(19) United States
(12) Patent Application Publication
(10) Pub. No.: US 2024/0136571 A1
(43) Pub. Date: Apr. 25, 2024

(54) POSITIVE ELECTRODE MATERIAL AND BATTERY

(71) Applicant: Panasonic Intellectual Property Management Co., Ltd., Osaka (JP)

(72) Inventors: KENTA NAGAMINE, Osaka (JP); IZURU SASAKI, Kyoto (JP)

(21) Appl. No.: 18/395,866

(22) Filed: Dec. 26, 2023

Related U.S. Application Data
(63) Continuation of application No. PCT/JP2022/026075, filed on Jun. 29, 2022.

(30) Foreign Application Priority Data
Jul. 18, 2021 (JP) 2021-119121

(51) Int. Cl. H01M 10/0562; H01M 4/02; H01M 4/62

(52) U.S. Cl. CPC H01M 10/0562; H01M 4/625; H01M 2004/028; H01M 2300/008; H01M 2300/0091

(57) ABSTRACT

A positive electrode material includes a positive electrode active material and a solid electrolyte. The oxidation potential of the solid electrolyte is higher than or equal to 3.9 V versus Li/Li⁺. The ratio of the volume of the solid electrolyte to the volume of the positive electrode material is in a range of greater than or equal to 8% and less than or equal to 25%. A battery of the present disclosure includes a positive electrode containing the positive electrode material, a negative electrode, and an electrolyte layer disposed between the positive electrode and the negative electrode.

### BACKGROUND

### 1. Technical Field

The present disclosure relates to a positive electrode material and a battery.

### 2. Description of the Related Art

Japanese Unexamined Patent Application Publication No. 2006-244734 discloses an all-solid battery containing a halide containing indium as a solid electrolyte.

### SUMMARY

In conventional technologies, the discharge capacity of a battery containing a solid electrolyte is demanded to be further improved.

In one general aspect, the techniques disclosed here feature a positive electrode material including a positive electrode active material and a solid electrolyte, wherein an oxidation potential of the solid electrolyte is higher than or equal to 3.9 V versus Li/Li⁺, and a ratio of a volume of the solid electrolyte to a volume of the positive electrode material is in a range of greater than or equal to 8% and less than or equal to 25%.

The present disclosure can improve the discharge capacity of a battery containing a solid electrolyte.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a schematic configuration of a positive electrode material in a first embodiment;

FIG. 2 is a sectional view of a schematic configuration of a battery in a second embodiment; and

FIG. 3 is a graph of a result of LSV measurement.

### DETAILED DESCRIPTIONS

### Underlying Knowledge Forming Basis of the Present Disclosure

Japanese Unexamined Patent Application Publication No. 2006-244734 states that the potential of the positive electrode active material versus Li is lower than or equal to 3.9 V on average. With this configuration, formation of a film formed of a decomposed product by the oxidation decomposition of the solid electrolyte can be prevented. As the positive electrode active material having a potential versus Li of lower than or equal to 3.9 V on average, typical layered transition metal oxides such as LiCoO₂ and LiNi_{0.8}Co_{0.15}Al_{0.05}O₂ are disclosed.

The present inventors have conducted study on the relation between the oxidation resistance of a halide solid electrolyte and battery characteristics. Consequently, it has been found that when the halide solid electrolyte is used for a positive electrode, even if the potential of the positive electrode active material versus Li is lower than or equal to 3.9 V on average, the halide solid electrolyte may oxidatively decompose during battery charging.

During battery charging, Li is released from the positive electrode active material, and the potential of the positive electrode active material increases. Then, the solid electrolyte being in contact with the positive electrode active material is exposed to a high potential. In this process, when the oxidation potential of the solid electrolyte is lower than 3.9 V, the oxidation of the solid electrolyte markedly occurs on the interface between the positive electrode active material and the solid electrolyte, and a deteriorated layer having poor lithium-ion conductivity is formed on the interface. It is considered that this deteriorated layer becomes a large resistance in the electrode reaction of the positive electrode and reduces the discharge capacity of the battery.

However, when the ratio of the volume of the solid electrolyte to the volume of a positive electrode material is larger than a certain value, even if part of the solid electrolyte changes to the deteriorated layer, the deteriorated layer has little effect on charging and discharging. That is, it is considered that the deteriorated layer has little effect on the discharge capacity. When the ratio of the volume of the solid electrolyte is smaller than or equal to the certain value, on the other hand, the ratio of the deteriorated layer to the entire volume of the solid electrolyte increases to the extent that the presence of the deteriorated layer cannot be ignored. Consequently, the deteriorated layer becomes a cause to hinder a charge-discharge reaction.

If the ratio of the volume of the solid electrolyte to the volume of the positive electrode material is sufficiently increased, the problem of the oxidative decomposition of the solid electrolyte hardly arises. However, if the ratio of the volume of the solid electrolyte to the volume of the positive electrode material is extremely increased, the discharge capacity of the battery decreases. Thus, to improve the discharge capacity of the battery containing the solid electrolyte, an approach from both aspects of the oxidation resistance of the solid electrolyte and the content ratio of the solid electrolyte in the positive electrode is important.

### Summary of Aspects of the Present Disclosure

A positive electrode material according to a first aspect of the present disclosure is a positive electrode material including:
a positive electrode active material; and
a solid electrolyte, wherein
an oxidation potential of the solid electrolyte is higher than or equal to 3.9 V versus Li/Li⁺, and
a ratio of a volume of the solid electrolyte to a volume of the positive electrode material is in a range of greater than or equal to 8% and less than or equal to 25%.

According to the first aspect, the discharge capacity of the battery containing the solid electrolyte can be improved.

In a second aspect of the present disclosure, for example, in the positive electrode material according to the first aspect, the ratio may be in a range of greater than or equal to 10% and less than or equal to 25%. With such a configuration, a higher discharge capacity can be achieved.

In a third aspect of the present disclosure, for example, in the positive electrode material according to the first aspect, the ratio may be in a range of greater than or equal to 13% and less than or equal to 25%. With such a configuration, a higher discharge capacity can be achieved.

In a fourth aspect of the present disclosure, for example, in the positive electrode material according to any one of the first to third aspects, the solid electrolyte may be represented by Formula (1) below, wherein a, b, and c may be each independently a value larger than 0; M may be at least one selected from the group consisting of metal elements other than Li and semi-metal elements; and X may be Cl or F. With such a configuration, a solid electrolyte with a high oxidation potential is easily obtained, and a high discharge capacity can be achieved.

LiₐM_{b}X_{c} (1)

In a fifth aspect of the present disclosure, for example, in the positive electrode material according to the fourth aspect, M may include a trivalent cation. With such a configuration, the solid electrolyte shows high ion conductivity.

In a sixth aspect of the present disclosure, for example, in the positive electrode material according to the fifth aspect, the trivalent cation may include Y. With such a configuration, the solid electrolyte shows high ion conductivity.

In a seventh aspect of the present disclosure, for example, in the positive electrode material according to any one of the fourth to sixth aspects, M may include a quadrivalent cation. With such a configuration, the solid electrolyte shows high ion conductivity.

In an eighth aspect of the present disclosure, for example, in the positive electrode material according to the seventh aspect, the quadrivalent cation may include Zr. With such a configuration, the solid electrolyte shows high ion conductivity.

In a ninth aspect of the present disclosure, for example, the positive electrode material according to any one of the first to eighth aspects may further contain a conductive additive. With such a configuration, more particles of the positive electrode active material can contribute to a reaction, which increases the discharge capacity.

In a 10th aspect of the present disclosure, for example, in the positive electrode material according to the ninth aspect, the conductive additive may contain a carbon material. By using the carbon material as the conductive additive, the weight energy density of the battery can be improved.

In an 11th aspect of the present disclosure, for example, in the positive electrode material according to any one of the first to 10th aspects, the positive electrode active material may have an electric conductivity of higher than or equal to 10⁻⁹ S/cm. The technique of the present disclosure is particularly effective when the electron conductivity of the positive electrode active material is high.

In a 12th aspect of the present disclosure, for example, the positive electrode material according to any one of the first to 11th aspects may further include a coating layer coating at least part of a surface of the positive electrode active material, wherein the coating layer may contain a lithium-containing oxide. With such a configuration, the discharge capacity of the battery is easily improved.

In a 13th aspect of the present disclosure, for example, in the positive electrode material according to the 12th aspect, the lithium-containing oxide may include lithium niobate. The coating layer containing lithium niobate easily improves the discharge capacity of the battery.

A battery according to a 14th aspect of the present disclosure includes:
a positive electrode containing the positive electrode material according to any one of the first to 13th aspects;
a negative electrode; and
an electrolyte layer disposed between the positive electrode and the negative electrode.

According to the 14th aspect, a battery having a high discharge capacity can be provided.

In a 15th aspect of the present disclosure, for example, in the battery according to the 14th aspect, the electrolyte layer may contain a sulfide solid electrolyte. When the sulfide solid electrolyte, which has excellent reduction stability, is contained, low-potential negative electrode materials such as graphite and metal lithium can be used, and the energy density of the battery can be improved.

The following describes embodiments of the present disclosure with reference to the accompanying drawings. The present disclosure is not limited by the following embodiments.

### First Embodiment

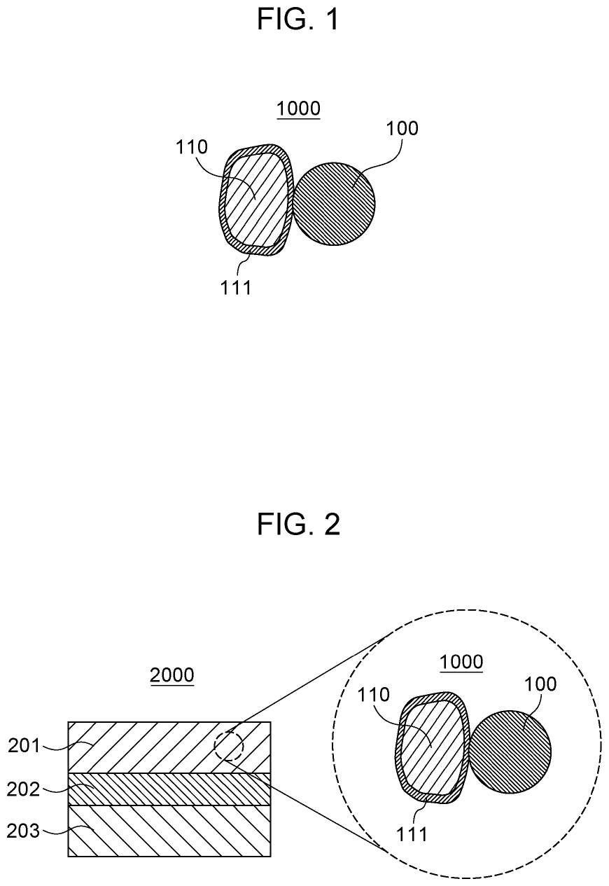

FIG. 1 is a sectional view of a schematic configuration of a positive electrode material 1000 in a first embodiment. The positive electrode material 1000 in the first embodiment includes a solid electrolyte 100 (a first solid electrolyte) and a positive electrode active material 110. The oxidation potential of the solid electrolyte 100 is higher than or equal to 3.9 V versus Li/Li⁺ (the equilibrium potential of a lithium metal electrode). The ratio (V_{SE}/V_{P}) of a volume V_{SE} of the solid electrolyte 100 to a volume V_{P} of the positive electrode material 1000 is in a range of 8% to 25% in terms of percentage.

When the solid electrolyte 100 having an oxidation potential of higher than or equal to 3.9 V is used, even if the ratio (V_{SE}/V_{P}) of the volume V_{SE} of the solid electrolyte 100 to the volume V_{P} of the positive electrode material 1000 is less than or equal to 25%, a high discharge capacity can be achieved. That is, even when the volume ratio of the solid electrolyte 100 is reduced, a high discharge capacity can be maintained. Thus, the configuration of the present disclosure is useful for improving the energy density of the battery.

When the ratio (V_{SE}/V_{P}) is less than 8%, the positive electrode active material 110 and the solid electrolyte 100 cannot sufficiently contact each other, and lithium-ion conduction is limited. Consequently, the discharge capacity reduces. When the ratio (V_{SE}/V_{P}) is greater than 25%, the use of the solid electrolyte 100 having an oxidation potential of higher than or equal to 3.9 V becomes less meaningful because, as described above, when the ratio of the volume of the solid electrolyte 100 to the volume of the positive electrode material 1000 is greater than a certain value, even if part of the solid electrolyte 100 changes to a deteriorated layer, the deteriorated layer has little effect on battery charging and discharging. If the ratio (V_{SE}/V_{P}) is greater than 25%, there is concern about a reduction in the discharge capacity caused by an increase in the solid electrolyte 100 and a decrease in the positive electrode active material 110.

The ratio (V_{SE}/V_{P}) may be in a range of 10% to 25% or in a range of 13% to 25%. With such a configuration, a higher discharge capacity can be achieved.

The ratio (V_{SE}/V_{P}) of the volume of the solid electrolyte 100 to the volume of the positive electrode material 1000 can be calculated from the amount of material charged and can also be calculated from the method described below. That is, a section of the positive electrode containing the positive electrode material 1000 is observed with a scanning electron microscope (SEM-EDX) to acquire a two-dimensional mapping image of elements. The measurement conditions of the scanning electron microscope for acquiring the two-dimensional mapping image include, for example, a magnification of 1,000-fold to 3,000-fold and an acceleration voltage of 5 kV. The two-dimensional mapping image is acquired with a resolution of 1,280×960. The two-dimensional mapping image of elements is analyzed, and the volume V_{P} of the positive electrode material 1000 and the volume V_{SE} of the solid electrolyte 100 can be identified from the number of pixels of elements contained in each of the positive electrode active material 110 and the solid electrolyte 100.

The upper limit value of the oxidation potential of the solid electrolyte 100 is not particularly limited. From the viewpoint of material selection, the upper limit value of the oxidation potential of the solid electrolyte 100 is 6.5 V. This value corresponds to the oxidation potential of fluorine.

The oxidation potential of the solid electrolyte 100 can be measured by performing linear sweep voltammetry (LSV) measurement for a battery for evaluation with this solid electrolyte 100 and an appropriate amount of a conductive additive contained as positive electrode materials. In the LSV measurement, when a swept potential reaches a certain potential, the solid electrolyte 100 oxidizes at that potential, and a current (for example, 0.05 mA) flows. The potential swept at this time can be regarded as the “oxidation potential.”

### Solid Electrolyte

The solid electrolyte 100 is represented by, for example, Formula (1) below:

LiₐM_{b}X_{c} (1)

In Formula (1), a, b, and c are each independently a value larger than 0. M is at least one selected from the group consisting of metal elements other than Li and semi-metal elements. X is Cl or F. With such a configuration, a solid electrolyte with a high oxidation potential is easily obtained, and a high discharge capacity can be achieved. Chlorine and fluorine have high electric negativity and thus exist stably as anions and are hard to be oxidized. It is thus considered that when the solid electrolyte 100 contains chlorine or fluorine as anions, the oxidation potential of the solid electrolyte 100 also easily increases.

The “semi-metal elements” include B, Si, Ge, As, Sb, and Te.

The “metal elements” include all the elements included in Group 1 to Group 12 of the periodic table except hydrogen and all the elements included in Group 13 to Group 16 except B, Si, Ge, As, Sb, Te, C, N, P, O, S, and Se. That is, the metal elements are an element group that can be cations when forming inorganic compounds with halogen compounds.

The solid electrolyte 100 is what is called a halide solid electrolyte. The halide solid electrolyte is a solid electrolyte containing a halogen. The halide solid electrolyte may be an electrolyte not containing sulfur. In this case, sulfur-containing gases such as a hydrogen sulfide gas can be prevented from being generated from the solid electrolyte 100.

In Formula (1), M may include a trivalent cation. The trivalent cation may include Y (=yttrium). That is, the solid electrolyte 100 may contain Y as a metal element. With such a configuration, the solid electrolyte 100 shows high ion conductivity. Thus, the charge-discharge efficiency of the battery can be improved.

In Formula (1), M may include a quadrivalent cation. The quadrivalent cation may include Zr (=zirconium). That is, the solid electrolyte 100 may contain Zr as a metal element. With such a configuration, the solid electrolyte 100 shows high ion conductivity. Thus, the charge-discharge efficiency of the battery can be improved.

In Formula (1), M may include both the trivalent cation and the quadrivalent cation. For example, M may include Y and Zr.

Specific examples of the solid electrolyte 100 include Li₃MX₆, Li₂MgX₄, Li₂FeX₄, Li(Al,Ga,In)X₄, and Li₃(Al,Ga,In)X₆. M is a metal or semi-metal element. X is F or Cl.

In the present disclosure, when elements in a formula is represented like “(Al,Ga,In),” this representation shows at least one element selected from the element group within the parentheses. That is, “(Al,Ga,In)” has the same meaning as “at least one selected from the group consisting of Al, Ga, and In.” The same applies to cases with other elements.

The solid electrolyte 100 may be Li_{2.7}Y_{1.1}Cl₆ or Li_{2.5}Y_{0.5}Zr_{0.5}Cl₆.

The solid electrolyte 100 has a particulate shape, for example. The shape of the particles of the solid electrolyte 100 is not particularly limited. The shape of the particles of the solid electrolyte 100 can be spherical, ellipsoidal, scaly, or fibrous.

The median diameter of the particles of the solid electrolyte 100 may be smaller than or equal to 100 μm. When the median diameter is smaller than or equal to 100 μm, the positive electrode active material 110 and the solid electrolyte 100 easily form a good dispersed state in a positive electrode. Consequently, the charge-discharge characteristics of the battery improve. The median diameter of the particles of the solid electrolyte 100 may be smaller than or equal to 10 μm. The median diameter of the particles of the solid electrolyte 100 may be larger than or equal to 0.1 μm.

The particles of the solid electrolyte 100 may have a smaller median diameter than the median diameter of the particles of the positive electrode active material 110. With such a configuration, the solid electrolyte 100 and the positive electrode active material 110 easily form a good dispersed state in the positive electrode.

In the present specification, the “median diameter” means a particle diameter when the cumulative volume in volume-based particle size distribution is equal to 50%. The volume-based particle size distribution is measured by, for example, a laser diffraction measurement apparatus or an image analysis apparatus.

The solid electrolyte 100 can be produced by the following method. The following exemplifies a method for producing a halide solid electrolyte represented by Formula (1).

In accordance with a desired composition, raw material powders of halides are provided. The halides may each be a compound containing two types of elements containing a halogen element. For example, when Li₃YCl₆ is produced, LiCl and YCl₃ are provided in a molar ratio of 3:1 as the raw material powder. In this process, by appropriately selecting the types of the raw material powders, the element types of “M” and “X” in Formula (1) can be determined. By adjusting the types of the raw material powders, the blending ratio of the raw material powders, and a synthesis process, the values “a,” “b,” and “c” in Formula (1) can be adjusted.

After mixing and pulverizing the raw material powders, the raw material powders are reacted using a method of mechanochemical milling. Alternatively, after mixing and pulverizing the raw material powders, the mixture may be heat-treated in vacuum or in an inert atmosphere. The heat treatment is performed, for example, under the conditions of 100° C. to 550° C. and longer than or equal to 1 hour. Through these steps, the halide solid electrolyte is obtained.

The configuration of a crystalline phase (that is, the crystal structure) of the halide solid electrolyte can be adjusted and determined by the reaction method and reaction conditions of the raw material powder.

### Positive Electrode Active Material

The positive electrode active material 110 contains a material having characteristics of occluding and releasing metal ions (for example, lithium ions). Examples of the positive electrode active material 110 include lithium-containing transition metal oxides, transition metal fluorides, polyanion materials, fluorinated polyanion materials, transition metal sulfides, transition metal oxy-sulfides, and transition metal oxy-nitrides. When a lithium-containing transition metal oxide is used as the positive electrode active material 110 in particular, battery production costs can be reduced and average discharge voltage can be improved. Examples of the lithium-containing transition metal oxides include Li(Ni,Co,Al)O₂, Li(Ni,Co,Mn)O₂, and LiCoO₂.

The positive electrode active material 110 may contain lithium nickel cobalt manganese oxide. With such a configuration, the energy density and the charge-discharge efficiency of the battery can be improved.

The positive electrode active material 110 has an electron conductivity of greater than or equal to 10⁻⁹ S/cm, for example. When the electron conductivity of the positive electrode active material 110 is high, the oxidation reaction of the solid electrolyte 100 is promoted. Thus, the technique of the present disclosure is particularly effective when the electron conductivity of the positive electrode active material 110 is high. The electron conductivity of the positive electrode active material 110 may be greater than or equal to 10⁻⁸ S/cm, greater than or equal to 10⁻⁷ S/cm, greater than or equal to 10⁻⁶ S/cm, greater than or equal to 10⁻⁵ S/cm, or greater than or equal to 10⁻⁴ S/cm. The upper limit value of the electron conductivity of the positive electrode active material 110 is not particularly limited and is, for example, 10⁶ S/cm.

The positive electrode active material 110 may be a lithium metal oxide having a layered rock salt structure. With such a configuration, higher charge-discharge characteristics can be achieved. Extraction and insertion of lithium from and into the lithium metal oxide having a layered rock salt structure smoothly proceed. The lithium metal oxide having a layered rock salt structure has a large capacity per unit weight. Thus, by using the lithium metal oxide having a layered rock salt structure as the positive electrode active material 110, high charge-discharge characteristics can be achieved.

The positive electrode active material 110 has a particulate shape, for example. The shape of the particles of the positive electrode active material 110 is not particularly limited. The shape of the particles of the positive electrode active material 110 can be spherical, ellipsoidal, scaly, or fibrous.

The median diameter of the particles of the positive electrode active material 110 may be larger than or equal to 0.1 μm and smaller than or equal to 100 μm. When the median diameter is larger than or equal to 0.1 μm, the positive electrode active material 110 and the solid electrolyte 100 easily form a good dispersed state in the positive electrode. Consequently, the charge-discharge characteristics of the battery improve. When the median diameter of the positive electrode active material 110 is smaller than or equal to 100 μm, a lithium diffusion velocity inside the particles of the positive electrode active material 110 is sufficiently ensured. Thus, battery operation with high output is facilitated.

The positive electrode material 1000 may contain a particle group of the solid electrolyte 100 and a particle group of the positive electrode active material 110.

### Coating Layer

The positive electrode material 1000 further includes a coating layer 111 coating at least part of a surface of the positive electrode active material 110. The coating layer 111 may coat the entire surface of the positive electrode active material 110 or coat only part of the surface of the positive electrode active material 110. The coating layer 111 contains a lithium-containing oxide. The positive electrode active material 110 and the solid electrolyte 100 are separated from each other via the coating layer 111. The positive electrode active material 110 may be in contact with the solid electrolyte 100 via the coating layer 111. The lithium-containing oxide has excellent high-potential stability. By using the lithium-containing oxide as the material of the coating layer 111, the discharge capacity of the battery is easily improved.

The particles of the positive electrode active material 110 are in direct contact with each other via portions not coated with the coating layer 111, thereby improving electron conductivity among the particles of the positive electrode active material 110. Thus, battery operation with high output is enabled.

In the example shown in FIG. 1, the solid electrolyte 100 and the coating layer 111 are in contact with each other.

The lithium-containing oxide can be a material having lithium-ion conductivity. The lithium-containing oxide can be a lithium-containing oxide solid electrolyte. Examples of the lithium-containing oxide solid electrolyte include Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—Ti—O compounds such as Li₂SO₄ and Li₄TisOi₂, Li—Zr—O compounds such as Li₂ZrO₃, Li—Mo—O compounds such as Li₂MoO₃, Li-V-O compounds such as LiV₂O₅, and Li—W—O compounds such as Li₂WO₄. The coating layer 111 may contain only one selected from these or contain a mixture of two or more.

The lithium-containing oxide typically contains lithium niobate. Lithium niobate has high ion conductivity, and thus the coating layer 111 containing lithium niobate easily improves the discharge capacity of the battery.

The method for forming the coating layer 111 on the surface of the positive electrode active material 110 is not particularly limited. Examples of the method for forming the coating layer 111 include a liquid phase coating method and a vapor phase coating method.

For example, in the liquid phase coating method, a precursor solution of a coating material is applied to the surface of the positive electrode active material 110. When the coating layer 111 containing LiNbO₃ is to be formed, the precursor solution can be a mixed solution (a sol solution) of a solvent, a lithium alkoxide, and a niobium alkoxide. Examples of the lithium alkoxide include lithium ethoxide. Examples of the niobium alkoxide include niobium ethoxide. The solvent is, for example, an alcohol such as ethanol. In accordance with a desired composition of the coating layer 111, the amounts of the lithium alkoxide and the niobium alkoxide are adjusted. As needed, water may be added to the precursor solution. The precursor solution may be either acidic or basic.

The method for applying the precursor solution to the surface of the positive electrode active material 110 is not particularly limited. For example, the precursor solution can be applied to the surface of the positive electrode active material 110 using a tumbling fluidized bed granulating-coating machine. With the tumbling fluidized bed granulating-coating machine, while the positive electrode active material 110 is tumbled and fluidized, the precursor solution is blown on the positive electrode active material 110, and the precursor solution can be applied to the surface of the positive electrode active material 110. With this operation, a precursor film is formed on the surface of the positive electrode active material 110. Subsequently, the positive electrode active material 110 coated with the precursor film is heat-treated. With the heat treatment, gelation of the precursor film proceeds, forming the coating layer 111.

Examples of the vapor phase coating method include a pulsed laser deposition (PLD) method, a vacuum deposition method, a sputtering method, a thermal chemical vapor deposition (CVD) method, and a plasma chemical vapor deposition method. For example, in the PLD method, an ion conductive material as a target is irradiated with a high-energy pulsed laser (for example, a KrF excimer laser, wavelength: 248 nm), and the sublimated ion conductive material is deposited on the surface of the positive electrode active material 110. When the coating layer 111 of LiNbO₃ is to be formed, LiNbO₃ sintered in high density is used as the target.

The thickness of the coating layer 111 may be larger than or equal to 1 nm and smaller than or equal to 100 nm. When the thickness of the coating layer 111 is larger than or equal to 1 nm, the positive electrode active material 110 and the solid electrolyte 100 can be prevented from being in direct contact with each other, and side reactions of the solid electrolyte 100 can be reduced. Thus, the charge-discharge efficiency of the battery can be improved. When the thickness of the coating layer 111 is smaller than or equal to 100 nm, the internal resistance of the battery can be sufficiently reduced. Consequently, the energy density of the battery increases.

The thickness of the coating layer 111 may be larger than or equal to 2 nm and smaller than or equal to 40 nm. With such a configuration, the above effect is easily produced.

### Other Materials

The positive electrode material 1000 may further contain a conductive additive. With such a configuration, a higher discharge capacity can be achieved. When the positive electrode of the battery contains the conductive additive, the particles of the positive electrode active material 110 are easily brought into electric contact with each other. Thus, more particles of the positive electrode active material 110 become able to contribute to a reaction, thus increasing the discharge capacity.

Examples of the conductive additive include graphite such as natural graphite and artificial graphite; carbon black such as acetylene black and Ketjen black; conductive fibers such as carbon fiber and metal fiber; metal powders such as carbon fluoride and aluminum; conductive whiskers such as zinc oxide and potassium titanate; conductive metal oxides such as titanium oxide; and conductive polymer compounds such as polyaniline, polypyrrole, and polythiophene. The conductive additive can be typically a carbon material. The carbon material has a lower density than that of a metallic material. A positive electrode containing a certain volume of the carbon material as the conductive additive is lighter in weight than a positive electrode containing a certain volume of the metallic material as the conductive additive. That is, by using the carbon material as the conductive additive, the weight energy density of the battery can be improved.

### Second Embodiment

The following describes a second embodiment. Descriptions overlapping with those of the first embodiment described above will be omitted as appropriate.

FIG. 2 is a sectional view of a schematic configuration of a battery 2000 in the second embodiment. The battery 2000 in the second embodiment includes a positive electrode 201, an electrolyte layer 202, and a negative electrode 203. The positive electrode 201 contains the positive electrode material 1000 in the first embodiment. The electrolyte layer 202 is disposed between the positive electrode 201 and the negative electrode 203. With such a configuration, the battery 2000 having a high discharge capacity can be achieved.

The thickness of the positive electrode 201 may be larger than or equal to 10 μm and smaller than or equal to 500 μm. When the thickness of the positive electrode 201 is larger than or equal to 10 μm, the energy density of the battery 2000 is sufficiently ensured. When the thickness of the positive electrode 201 is smaller than or equal to 500 μm, operation with high output is enabled.

The electrolyte layer 202 is a layer containing an electrolyte. The electrolyte is, for example, a solid electrolyte (that is, a second solid electrolyte). That is, the electrolyte layer 202 may be a solid electrolyte layer.

Examples of the second solid electrolyte include the first solid electrolyte in the first embodiment. That is, the electrolyte layer 202 may contain the first solid electrolyte in the first embodiment. With such a configuration, the charge-discharge efficiency of the battery 2000 can be improved.

The second solid electrolyte may be a halide solid electrolyte different from the first solid electrolyte in the first embodiment. That is, the electrolyte layer 202 may contain a halide solid electrolyte different from the first solid electrolyte in the first embodiment. With such a configuration, the output density and the charge-discharge efficiency of the battery 2000 can be improved.

The halide solid electrolyte contained in the electrolyte layer 202 may contain Y as a metal element. With such a configuration, the output density and the charge-discharge efficiency of the battery can be improved.

Examples of the halide solid electrolyte contained in the electrolyte layer 202 include the materials shown as the first solid electrolyte in the first embodiment.

As the second solid electrolyte, a sulfide solid electrolyte may be used. That is, the electrolyte layer 202 may contain a sulfide solid electrolyte. When the sulfide solid electrolyte, which has excellent reduction stability, is contained, low-potential negative electrode materials such as graphite and metal lithium can be used, and the energy density of the battery 2000 can be improved.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂. To these, LiX, Li₂O, MO_{q}, LiₚMO_{q}, or the like may be added. The element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. The letters p and q in “MO_{q}” and “LiₚMO_{q}” are each independently a natural number.

As the second solid electrolyte, an oxide solid electrolyte, a polymeric solid electrolyte, or a complex hydride solid electrolyte may be used.

Examples of the oxide solid electrolyte include NASICON type solid electrolytes represented by LiTi₂(PO₄)₃ and element substitution products thereof, (LaLi)TiO₃-based perovskite type solid electrolytes, LISICON type solid electrolytes represented by Li₁₄ZnGe₄O₁₆, Li₄SiO₄, LiGeO₄, and element substitution products thereof, garnet type solid electrolytes represented by Li₇La₃Zr₂O₁₂ and element substitution products thereof, Li₃N and H substitution products thereof, Li₃PO₄ and N substitution products thereof, and glasses or glass ceramics in which materials such as Li₂SO₄ and Li₂CO₃ are added to base materials containing Li—B—O compounds such as LiBO₂ and Li₃BO₃.

Examples of the polymeric solid electrolyte include compounds of a polymer compound and a lithium salt. The polymer compound may have an ethylene oxide structure. Having the ethylene oxide structure enables the polymer compound to contain the lithium salt in a large amount and can thus further improve ion conductivity. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one lithium salt selected from these may be used alone, or a mixture of two or more lithium salts selected from these may be used.

Examples of the complex hydride solid electrolyte include LiBH₄—LiI and LiBH₄—P₂S₅.

The electrolyte layer 202 may contain the solid electrolyte as a main component. That is, the electrolyte layer 202 may contain the second solid electrolyte in an amount of greater than or equal to 50% in terms of weight ratio to the entire weight of the electrolyte layer 202 (that is, greater than or equal to 50% by weight). With such a configuration, the charge-discharge characteristics of the battery 2000 can be improved.

The electrolyte layer 202 may contain the second solid electrolyte in an amount of greater than or equal to 70% in terms of weight ratio to the entire weight of the electrolyte layer 202 (greater than or equal to 70% by weight). With such a configuration, the charge-discharge characteristics of the battery 2000 can be improved.

The electrolyte layer 202 may contain inevitable impurities such as starting raw materials used when the second solid electrolyte is synthesized, by-products, and decomposed products while containing the second solid electrolyte as a main component.

The electrolyte layer 202 may contain the second solid electrolyte in an amount of 100% in terms of weight ratio to the entire weight of the electrolyte layer 202 (100% by weight) except for inevitable impurities. With such a configuration, the charge-discharge characteristics of the battery 2000 can be improved.

The electrolyte layer 202 may contain only the second solid electrolyte.

The electrolyte layer 202 may contain two or more selected from the materials exemplified as the second solid electrolyte. For example, the electrolyte layer 202 may contain the halide solid electrolyte and the sulfide solid electrolyte.

The thickness of the electrolyte layer 202 may be larger than or equal to 1 μm and smaller than or equal to 300 μm. When the thickness of the electrolyte layer 202 is larger than or equal to 1 μm, the possibility of the positive electrode 201 and the negative electrode 203 becoming short-circuited is low. When the thickness of the electrolyte layer 202 is smaller than or equal to 300 am, operation with high output is facilitated. That is, when the thickness of the electrolyte layer 202 is appropriately adjusted, sufficient safety of the battery 2000 can be ensured and the battery 2000 can be operated with high output.

The negative electrode 203 contains a material having characteristics of occluding and releasing metal ions (for example, lithium ions). The negative electrode 203 contains a negative electrode active material, for example.

For the negative electrode active material, a metallic material, a carbon material, an oxide, a nitride, a tin compound, a silicon compound, or the like can be used. The metallic material may be a single metal or an alloy. Examples of the metallic material include lithium metal and lithium alloys. Examples of the carbon material include natural graphite, cokes, graphitizing carbon, carbon fiber, spherical carbon, artificial graphite, and amorphous carbon. From the viewpoint of capacity density, silicon (Si), tin (Sn), silicon compounds, or tin compounds can be suitably used.

The negative electrode 203 may contain a third solid electrolyte. With such a configuration, lithium-ion conductivity inside the negative electrode 203 increases, and the battery 2000 can be operated with high output. As the third solid electrolyte, the materials exemplified as the second solid electrolyte of the electrolyte layer 202 can be used.

The shape of the negative electrode active material may be particulate. The median diameter of the particles of the negative electrode active material may be larger than or equal to 0.1 μm and smaller than or equal to 100 μm. When the median diameter of the particles of the negative electrode active material is larger than or equal to 0.1 μm, the negative electrode active material and the solid electrolyte can form a good dispersed state in the negative electrode 203. Thus, the charge-discharge characteristics of the battery 2000 can be improved. When the median diameter of the particles of the negative electrode active material is smaller than or equal to 100 μm, the diffusion velocity of lithium inside the negative electrode active material is sufficiently ensured. Thus, the battery 2000 can be operated with high output.

The median diameter of the particles of the negative electrode active material may be larger than the median diameter of the third solid electrolyte. With such a configuration, a good dispersed state of the negative electrode active material and the solid electrolyte can be formed.

In the negative electrode 203, the volume ratio “v2:(100−v2)” between the negative electrode active material and the solid electrolyte may satisfy the relation 30≤v2≤95. When 30≤v2 is satisfied, the energy density of the battery 2000 is easily ensured. When v2≤95 is satisfied, the operation of the battery 2000 with high output is facilitated.

The thickness of the negative electrode 203 may be larger than or equal to 10 μm and smaller than or equal to 500 μm. When the thickness of the negative electrode 203 is larger than or equal to 10 μm, the energy density of the battery 2000 is easily ensured. When the thickness of the negative electrode 203 is smaller than or equal to 500 am, the operation of the battery 2000 with high output is facilitated.

At least one of the positive electrode 201, the electrolyte layer 202, and the negative electrode 203 may contain a binder for the purpose of improving adhesion among particles. The binder is used for improving the bindability of the materials forming the electrode. Examples of the binder include polyvinylidene fluoride, polytetrafluoroethylene, polyethylene, polypropylene, an aramid resin, polyamide, polyimide, polyamideimide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinyl pyrrolidone, polyether, polyethersulfone, hexafluoropolypropylene, a styrene-butadiene rubber, and carboxymethyl cellulose. Examples of the binder also include copolymers of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethylvinyl ether, acrylic acid, and hexadiene. Two or more selected from these may be combined with each other to be used as the binder.

The negative electrode 203 may contain a conductive additive for the purpose of improving electron conductivity. Examples of the conductive additive include the materials described above. When the carbon material is used as the conductive additive, costs can be reduced.

The battery 2000 can be formed as batteries of various shapes such as a coin shape, a cylindrical shape, a square shape, a sheet shape, a button shape, a flat shape, and a laminate shape.

The battery 2000 can be produced by preparing the positive electrode material 1000 of the first embodiment, the material of the electrolyte layer 202, and the material of the negative electrode 203 and producing a laminate in which the positive electrode 201, the electrolyte layer 202, and the negative electrode 203 are disposed in this order.

### EXAMPLES

The following describes the details of the present disclosure using examples and comparative examples.

### Example 1

### Production of Coating Active Material

Within an argon glove box, 5.95 g of ethoxy lithium (manufactured by Kojundo Chemical Lab. Co., Ltd.) and 36.43 g of pentaethoxy niobium (manufactured by Kojundo Chemical Lab. Co., Ltd.) were dissolved in 500 mL of ultra-dehydrated ethanol (manufactured by Wako Pure Chemical Corporation) to produce a coating solution.

A powder of Li(Ni,Co,Mn)O₂ (hereinafter, denoted as NCM) was prepared as a positive electrode active material. For processing for forming a coating layer of LiNbO₃ on the surface of NCM, a tumbling fluidized bed granulating-coating machine (FD-MP-01E manufactured by Powrex Corporation) was used. The charging amount of NCM, the stirring number of revolutions, and the coating solution feeding rate were 1 kg, 400 rpm, and 6.59 g/minute, respectively. After the end of the processing for forming the coating layer of LiNbO₃, the obtained powder was put into a crucible made of alumina and was heat-treated under the conditions of the atmosphere, 300° C., and 1 hour. The powder after the heat treatment was pulverized again using an agate mortar. With this operation, NCM having the coating layer of LiNbO₃ was obtained. The coating layer was formed of lithium niobate (LiNbO₃). In the following, NCM having the coating layer of LiNbO₃ is denoted as “NCM-LNO.”

### Production of Solid Electrolyte

Within an argon glove box with a dew point of lower than or equal to −60° C., LiCl and YCl₃ as raw material powders were prepared with a molar ratio of LiCl:YCl₃=2.7:1.1. These were mixed together to obtain a mixture. Next, using a planetary ball mill (Type P-7 manufactured by Fritsch), the mixture was subjected to milling processing under the conditions of 25 hours and 600 rpm. With this operation, a powder of Li_{2.7}Y_{1.1}Cl₆ as a halide solid electrolyte was obtained. In the following, Li_{2.7}Y_{1.1}Cl₆ is denoted as “LYC.”

### Measurement of Ion Conductivity of LYC

In a dry atmosphere with a dew point of lower than or equal to −30° C., LYC was charged into a die for pressurizing molding. LYC was unidirectionally pressurized at a pressure of 400 MPa to produce a cell for conductivity measurement. The die for pressurizing molding includes a die made of polycarbonate, a punch upper part made of stainless, and a punch lower part made of stainless. While maintaining a pressurized state, a lead was taken out of each of the punch upper part and the punch lower part, and the leads were connected to a potentiostat (VersaSTAT 4 manufactured by Princeton Applied Research) equipped with a frequency response analyzer. By an electrochemical method for measuring impedance, ion conductivity at room temperature was measured. The real value of an impedance of a measurement point having the smallest absolute value of the phase of a complex impedance was regarded as a resistance value for the ion conduction of LYC. Using this resistance value, an ion conductivity R_{SE} was calculated based on Equation (2) below:

σ=(R_{SE}×S/t)¹ (2)

In Equation (2), a represents ion conductivity, S the area of the electrolyte, R_{SE} the resistance value of the solid electrolyte in impedance measurement, and t the thickness of the electrolyte.

Table 1 lists the result. The ion conductivity of LYC was 0.2 mS/cm.

### Production of Sulfide Solid Electrolyte

Within an argon glove box with a dew point of lower than or equal to −60° C., Li₂S and P₂S₅ were prepared with a molar ratio of Li₂S:P₂S5=75:25. These were pulverized and mixed together using a mortar to obtain a mixture. Subsequently, using a planetary ball mill (Type P-7 manufactured by Fritsch), the mixture was subjected to milling processing under the conditions of 10 hours and 510 rpm. With this operation, a glassy solid electrolyte was obtained. The glassy solid electrolyte was heat-treated under the conditions of an inert atmosphere, 270° C., and 2 hours. With this operation, Li₂S—P₂S₅ as a glass ceramic solid electrolyte was obtained. In the following, Li₂S—P₂S₅ is denoted as “LPS.”

### Production of Secondary Battery

In an argon atmosphere with a dew point of lower than or equal to −60° C., NCM-LNO, LYC, and a conductive additive (VGCF manufactured by Showa Denko K. K.) were prepared with a mass ratio of 85:14:1. These were mixed together using an agate mortar to produce a positive electrode material. “VGCF” is a registered trademark of Showa Denko K. K.

Into an insulating outer tube, 80 mg of LPS, 20 mg of LYBC, and 19.5 mg of the positive electrode material described above were put in this order. Pressure at 720 MPa was applied to these materials to obtain a laminate of a positive electrode and a solid electrolyte layer. Next, a Li foil was disposed so as to be in contact with the solid electrolyte layer. Pressure at 80 MPa was applied to the laminate of the positive electrode, the solid electrolyte layer, and the Li foil. Next, respective collectors made of stainless steel were disposed on the top and bottom of the laminate, and respective collection leads were attached to the collectors. Finally, the insulating outer tube was hermetically sealed with an insulating ferrule so that the inside of the insulating outer tube was insulated from an outer-air atmosphere. Thus, a secondary battery of Example 1 was obtained.

### Charge-Discharge Test

The secondary battery of Example 1 was placed in a 25° C. thermostat oven. The secondary battery was charged with a constant current with a current value of 0.140 mA, and charging was ended with a voltage of 4.3 V. Next, the secondary battery was discharged with the same current value of 0.140 mA, and discharging was ended with a voltage of 2.5 V. As listed in Table 2, the discharge capacity of the secondary battery of Example 1 was 203 mAh/g.

### Examples 2 to 8

Secondary batteries of Examples 2 to 8 were produced in the same manner as in Example 1 except that the positive electrode materials were produced with the ratios listed in Table 2. The discharge capacity of the secondary batteries of Examples 2 to 8 was measured in the same manner as in Example 1. Table 2 lists the results.

### Examples 9 and 10

### Production of Halide Solid Electrolyte

In an argon atmosphere with a dew point of lower than or equal to −60° C., LiCl, YCl₃, and ZrCl₄ as raw material powders were prepared with a molar ratio of LiCl:YCl₃:ZrCl₄=2.5:0.5:0.5. Using a planetary ball mill, these raw material powders were mixed together under the conditions of 100 rpm and 1 hour to obtain a mixture. Subsequently, using the planetary ball mill in the same manner, the mixture was processed under the conditions of 600 rpm and 12 hours. With this operation, a powder of Li_{2.5}Y_{0.5}Zr_{0.5}Cl₆ as a halide solid electrolyte was obtained. In the following, Li_{2.5}Y_{0.5}Zr_{0.5}Cl₆ is denoted as “LYZC.”

The ion conductivity of LYZC was measured in the same manner as in the measurement of the ion conductivity of LYC. Table 1 lists the result. The ion conductivity of LYZC was 1.1 mS/cm.

### Production of Secondary Battery

Secondary batteries of Examples 9 and 10 were produced in the same manner as in Example 1 except that the positive electrode materials were produced with the ratios listed in Table 2. The discharge capacity of the secondary batteries of Examples 9 and 10 was measured in the same manner as in Example 1. Table 2 lists the results.

### Reference Example 1

A secondary battery of Reference Example 1 was produced in the same manner as in Example 1 except that the positive electrode material was produced with the ratio listed in Table 2. The discharge capacity of the secondary battery of Reference Example 1 was measured in the same manner as in Example 1. Table 2 lists the result.

### Comparative Examples 1 to 5

### Production of Halide Solid Electrolyte

In an argon atmosphere with a dew point of lower than or equal to −60° C., LiCl, YCl₃, and YBr₃ as raw material powders were prepared with a molar ratio of LiCl:YBr₃:YCl₃=3.000:0.666:0.333. These were pulverized and mixed together using a mortar to obtain a mixture. Next, using an electric furnace, the mixture was heat-treated under the conditions of an argon atmosphere, 500° C., and 3 hours. The product was pulverized using a pestle and a mortar. With this operation, a powder of Li₃YBr₂Cl₄ as a halide solid electrolyte was obtained. In the following, Li₃YBr₂Cl₄ is denoted as “LYBC.”

The ion conductivity of LYBC was measured in the same manner as in the measurement of the ion conductivity of LYC. Table 1 lists the result. The ion conductivity of LYBC was 1.4 mS/cm.

### Production of Secondary Battery

Secondary batteries of Comparative Examples 1 to 5 were produced in the same manner as in Example 1 except that the positive electrode materials were produced with the ratios listed in Table 2. The discharge capacity of the secondary batteries of Comparative Examples 1 to 5 was measured in the same manner as in Example 1. Table 2 lists the results.

### Measurement of Oxidation Potential of Solid Electrolyte

### Production of Battery 1 for Evaluation

In an argon atmosphere with a dew point of lower than or equal to −60° C., LYC and acetylene black were prepared with a mass ratio of 93:7. These were mixed together using an agate mortar to obtain a mixture. Into an insulating outer tube, 80 mg of a sulfide solid electrolyte, 20 mg of LYBC, and 5 mg of the mixed material described above were put in this order. A powder of LPS was used as the sulfide solid electrolyte. Pressure at 720 MPa was applied to the obtained laminate. Next, an In—Li foil as a negative electrode was laminated on the layer of the sulfide solid electrolyte. Pressure at 80 MPa was applied to the laminate of the mixed material, the electrolyte layer, and the negative electrode. Next, respective collectors made of stainless steel were disposed on the top and bottom of the laminate. Respective collection leads were attached to the collectors. Finally, the insulating outer tube was hermetically sealed using an insulating ferrule to insulate the inside of the insulating outer tube from an outer-air atmosphere. Thus, Battery 1 for evaluation for evaluating the oxidation potential of LYC was obtained. Battery 1 for evaluation had a laminate structure of (LYC+acetylene black)/LYBC/sulfide solid electrolyte layer/In—Li.

### Production of Battery 2 for Evaluation

Battery 2 for evaluation was produced in the same manner as for Battery 1 for evaluation except that LYZC was used instead of LYC. Battery 2 for evaluation had a laminate structure of (LYZC+acetylene black)/LYBC/sulfide solid electrolyte layer/In—Li.

### Production of Battery 3 for Evaluation

Battery 3 for evaluation was produced in the same manner as for Battery 1 for evaluation except that LYBC was used instead of LYC. Battery 3 for evaluation had a laminate structure of (LYBC+acetylene black)/LYBC/sulfide solid electrolyte layer/In—Li.

LSV Measurement

Linear sweep voltammetry (LSV) measurement for the batteries for evaluation was performed. First, a battery for evaluation was placed in a thermostat oven set at 25° C. The battery for evaluation was connected to a potentiogalvanostat to perform LSV measurement. In the LSV measurement, the sweeping speed was set at 10 mV/s. The scanning range was set from the open circuit voltage (OCV) to 4.0 V vs. In—Li. In the LSV measurement, the current response when the potential was swept from OCV to 4.0 V was plotted.

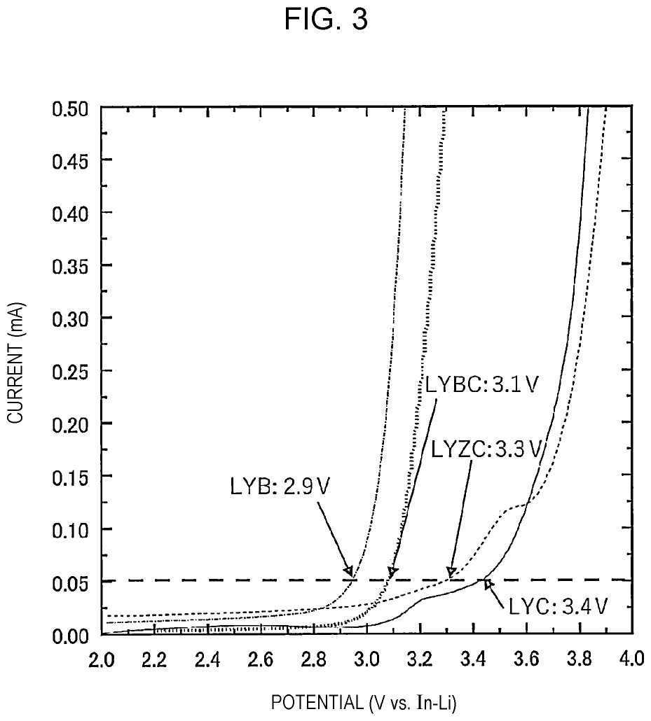

FIG. 3 is a graph of results of the LSV measurement. In the LSV measurement, when the swept potential reaches a certain potential, the solid electrolyte oxidizes at that potential, and a current (for example, 0.05 mA) flows. As can be understood from FIG. 3, LYC had an oxidation potential of 3.4 V versus In—Li. LYZC had an oxidation potential of 3.3 V versus In—Li. LYBC had an oxidation potential of 3.1 V versus In—Li. The potential of the In—Li alloy versus Li is 0.6 V. Thus, the oxidation potential of LYC versus Li is 4.0 V. The oxidation potential of LYZC versus Li is 3.9 V. The oxidation potential of LYBC versus Li is 3.7 V.

FIG. 3 also shows a result of the LSV measurement of a halide solid electrolyte having a composition of Li₃YBr₆. The measurement result of Li₃YBr₆ is indicated by “LYB.” Li₃YBr₆ was produced by the following method. That is, within an argon glove box with a dew point of lower than or equal to −60° C., LiBr and YBr₃ as raw material powders were prepared in a molar ratio of LiBr:YBr₃=3:1. These were mixed together to obtain a mixture. Next, using a planetary ball mill, the mixture was subjected to milling processing under conditions of a number of revolutions of 600 rpm and 25 hours. With this operation, a powder of Li₃YBr₆ as a halide solid electrolyte was obtained. As shown in FIG. 3, LYB had an oxidation potential of 2.9 V versus In—Li. The oxidation potential of LYB versus Li is 3.5 V.

TABLE 1

| | | Oxidation potential |
|---|---|---|
| | σ (mS/cm) | (V vs. Li/Li⁺) |
| LYBC | 1.4 | 3.7 |
| LYZC | 1.1 | 3.9 |
| LYC | 0.2 | 4.0 |
| LYB | 0.6 | 3.5 |

TABLE 2

| | | Mass | | | Volume | | | |
|---|---|---|---|---|---|---|---|---|
| | | ratio | | | ratio | | | |
| | | (mass %) | | | (vol %) | | | Discharge |
| | Solid | Active | Solid | Conductive | Active | Solid | Conductive | capacity |
| | electrolyte | material | electrolyte | additive | material | electrolyte | additive | (%) |
| Example 1 | LYC | 85.0 | 14.0 | 1.0 | 75.0 | 23.1 | 1.9 | 99 |
| Example 2 | LYC | 85.1 | 12.8 | 2.0 | 75.0 | 21.2 | 3.8 | 96 |
| Example 3 | LYC | 88.3 | 11.7 | 0.0 | 80.1 | 19.9 | 0.0 | 89 |
| Example 4 | LYC | 88.3 | 11.2 | 0.5 | 80.0 | 19.0 | 1.0 | 95 |
| Example 5 | LYC | 88.4 | 10.6 | 1.0 | 80.0 | 18.1 | 1.9 | 98 |
| Example 6 | LYC | 88.5 | 9.5 | 2.0 | 80.0 | 16.1 | 3.9 | 95 |
| Example 7 | LYC | 91.5 | 7.4 | 1.0 | 85.0 | 13.0 | 2.0 | 92 |
| Example 8 | LYC | 93.3 | 5.7 | 1.0 | 87.9 | 10.1 | 2.0 | 77 |
| Example 9 | LYZC | 87.3 | 11.7 | 1.0 | 80.1 | 18.0 | 2.0 | 90 |
| Example 10 | LYZC | 83.6 | 15.4 | 1.0 | 75.1 | 23.0 | 1.9 | 97 |
| Reference | LYC | 82.0 | 16.0 | 2.0 | 70.1 | 26.3 | 3.7 | 100 |
| Example 1 | | | | | | | | |
| Comparative | LYBC | 80.0 | 18.0 | 2.0 | 70.4 | 25.9 | 3.7 | 100 |
| Example 1 | | | | | | | | |
| Comparative | LYBC | 83.3 | 15.7 | 1.0 | 75.1 | 23.0 | 1.9 | 84 |
| Example 2 | | | | | | | | |
| Comparative | LYBC | 87.0 | 12.5 | 0.5 | 80.3 | 18.8 | 1.0 | 85 |
| Example 3 | | | | | | | | |
| Comparative | LYBC | 87.0 | 12.0 | 1.0 | 80.1 | 18.0 | 1.9 | 81 |
| Example 4 | | | | | | | | |
| Comparative | LYBC | 87.2 | 10.8 | 2.0 | 80.0 | 16.1 | 3.9 | 70 |
| Example 5 | | | | | | | | |

*Discharge capacity is the ratio to the discharge capacity of Reference Example 1.

Consideration

As listed in Table 2, as can be understood by comparing the result of Comparative Example 1 and the result of Reference Example 1 with each other, in the region where the volume ratio is greater than or equal to about 26%, there was no significant difference in the discharge capacity between the case in which LYBC was used as the solid electrolyte and the case in which LYC was used.

As can be understood by comparing the result of Example 1 and the result of Comparative Example 2 with each other, on the other hand, in the region where the volume ratio is less than 26%, the battery discharge capacity of the battery of Comparative Example 2, where LYBC was used as the solid electrolyte, was smaller than the discharge capacity of the battery of Example 1, where LYC was used. The same fact can also be understood from a comparison between the results of Examples 4 to 6 and the results of Comparative Examples 3 to 5. For example, in Example 8, even though the ratio of the solid electrolyte is as low as about 10% by mass, the discharge capacity of Example 8 (77%) was larger than the discharge capacity of Comparative Example 5 (70%), where the ratio of the solid electrolyte was about 16%. It can be said from the result of Example 8 that the ratio of the solid electrolyte may be greater than or equal to 8% or greater than or equal to 10%. The batteries of Examples 9 and 10, where LYZC was used, also showed a discharge capacity comparable to that of the batteries of the examples, where LYC was used.

The cause of the small discharge capacity of the batteries using LYBC can be inferred as follows. That is, when LYBC is used as the solid electrolyte, during battery charging, the solid electrolyte is exposed to the potential of the positive electrode, and LYBC markedly oxidizes. When the volume ratio is higher, the ratio of the area of a contact face between the solid electrolyte and the positive electrode active material to the surface area of the solid electrolyte is lower. Thus, the oxidation of the solid electrolyte occurring near the positive electrode active material has relatively small effect on the discharge capacity of the battery. When the volume ratio is lower, on the other hand, the ratio of the area of the contact face between the solid electrolyte and the positive electrode active material to the surface area of the solid electrolyte is higher. Thus, the effect of the oxidation of the solid electrolyte is larger, leading to a reduction in the discharge capacity of the battery.

As listed in Table 1, the ion conductivity of LYBC was about 1.4 mS/cm. The ion conductivity of LYC was about 0.2 mS/cm. In a charge-discharge reaction in a solid battery, the solid electrolyte plays a role of transporting carriers, and thus the higher the ion conductivity of the solid electrolyte, the more the resistance as a battery reduces, and the more the discharge capacity increases. The lower the volume ratio of the solid electrolyte, the more conspicuous this trend becomes. As listed in Table 1, however, the discharge capacity of the batteries using LYC, which has lower ion conductivity, surpassed that of the batteries using LYBC, which has higher ion conductivity. It can be said from this fact that the configuration of the present disclosure has produced a noticeable effect.

### Oxidation Potential of LTAF

When a battery containing Li_{2.7}Ti_{0.3}Al_{0.7}F₆(LTAF) as a halide solid electrolyte was produced, and LSV measurement was performed, no oxidation current flowed until 10 V. In other words, the oxidation potential of LTAF was higher than or equal to 10 V. The battery used for the LSV measurement had a laminate structure of positive electrode active material (450 μm)/LTAF (150 μm)/LYC (450 μm)/negative electrode active material. An In—Li alloy was used as the negative electrode active material. A mixture containing a SUS powder and LTAF with a volume ratio of 1:1 was used as the positive electrode active material. LTAF was produced by the following method.

Within an argon-atmosphere glove box with a dew point of lower than or equal to −60° C. and an oxygen value of less than or equal to 5 ppm, LiF, AlF₃, and TiF₄ as raw material powders were weighed so as to give a molar ratio of LiF:AlF₃:TiF₄=2.7:0.7:0.3. These raw material powders were mixed together using an agate mortar to obtain a mixture. Next, using a planetary ball mill (Type P-7 manufactured by Fritsch), the mixture was subjected to milling processing under the conditions of 12 hours and 500 rpm. With this operation, a halide solid electrolyte represented by the formula Li_{2.7}Al_{0.7}Ti_{0.3F6} was obtained.

The technique of the present disclosure is useful for, for example, an all-solid lithium secondary battery.

What is claimed is:

1. A positive electrode material comprising:
a positive electrode active material; and
a solid electrolyte, wherein
an oxidation potential of the solid electrolyte is higher than or equal to 3.9 V versus Li/Li⁺, and
a ratio of a volume of the solid electrolyte to a volume of the positive electrode material is in a range of greater than or equal to 8% and less than or equal to 25%.

2. The positive electrode material according to claim 1, wherein the ratio is in a range of greater than or equal to 10% and less than or equal to 25%.

3. The positive electrode material according to claim 1, wherein the ratio is in a range of greater than or equal to 13% and less than or equal to 25%.

4. The positive electrode material according to claim 1, wherein the solid electrolyte is represented by Formula (1) below:
LiₐM_{b}X_{c} (1)
wherein a, b, and c are each independently a value larger than 0;
M is at least one selected from the group consisting of metal elements other than Li and semi-metal elements; and
X is Cl or F.

5. The positive electrode material according to claim 4, wherein M includes a trivalent cation.

6. The positive electrode material according to claim 5, wherein the trivalent cation includes Y.

7. The positive electrode material according to claim 4, wherein M includes a quadrivalent cation.

8. The positive electrode material according to claim 7, wherein the quadrivalent cation includes Zr.

9. The positive electrode material according to claim 1, further comprising a conductive additive.

10. The positive electrode material according to claim 9, wherein the conductive additive contains a carbon material.

11. The positive electrode material according to claim 1, wherein the positive electrode active material has an electric conductivity of higher than or equal to 10⁻⁹ S/cm.

12. The positive electrode material according to claim 1, further comprising a coating layer coating at least part of a surface of the positive electrode active material, wherein the coating layer contains a lithium-containing oxide.

13. The positive electrode material according to claim 12, wherein the lithium-containing oxide includes lithium niobate.

14. A battery comprising:
a positive electrode containing the positive electrode material according to claim 1;
a negative electrode; and
an electrolyte layer disposed between the positive electrode and the negative electrode.

15. The battery according to claim 14, wherein the electrolyte layer contains a sulfide solid electrolyte.
